(19) United States
(12) Patent Application Publication
(10) Pub. No.: US 2005/0174607 A1
(43) Pub. Date: Aug. 11, 2005

(54) Diagnostic tool with fax transmission capability

(76) Inventors: David G. Hille, Brush Prairie, WA (US); Kenneth L. Buswell, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/774,030

(22) Filed: Feb. 5, 2004

(51) Int. Cl. H04N 1/00; H04M 11/00; G01D 3/00; G06F 11/30

(52) U.S. Cl. 358/406; 702/108; 702/183; 379/100.05

(57) ABSTRACT

A diagnostic tool includes a fax test module, a display and a processor. The fax test module includes a telephone connector, a fax modem module and a phone line emulator. The processor causes menus to be shown on the display. The menus allow a user to select tests to be performed on a device under test. The tests include a send fax test, and a receive fax test. The menus list devices that can be tested by the diagnostic tool, and the menus list at least one device that does not have fax capability and at least one device that does have fax capability.

### BACKGROUND

Stores receive millions of dollars of returns of products. Sometimes the returns result from defective products. Other times the returns result from customer dissatisfaction with a product despite no product defect. If a product is defective, the product is generally returned to the manufacturer. If the product is not defective, it is advantageous to both the stores and the manufacturer if the product can be resold without returning the product to the manufacturer.

Before reselling a returned product, it is desirable that a store be able to test the product to assure proper operation. For example, Hewlett-Packard Company provides a diagnostic tool to stores that allow stores to perform tests to aid in the determination of whether returned printers are faulty.

With the increased popularity of “all-in-one” units, printers are increasingly bundled with other capabilities such as fax and scanning capability. Currently available diagnostic tools do not include the capability to perform field testing for correct fax operation.

### SUMMARY OF THE INVENTION

A diagnostic tool includes a fax test module, a display and a processor. The fax test module includes a telephone connector, a fax modem module and a phone line emulator. The processor causes menus to be shown on the display. The menus allow a user to select tests to be performed on a device under test. The tests include a send fax test, and a receive fax test.

The menus list devices that can be tested by the diagnostic tool, and the menus list at least one device that does not have fax capability and at least one device that does have fax capability.

### BRIEF DESCRIPTION OF THE DRAWINGS

FIG. 1 and FIG. 2 are simplified diagrams of a handheld diagnostic tool that performs fax testing in accordance with an embodiment of the present invention.

FIG. 3 is a simplified block diagram of the handheld diagnostic tool shown in FIG. 1 in accordance with an embodiment of the present invention.

FIG. 4, FIG. 5, FIG. 6 and FIG. 7 show example simplified screens displayed on a display of the handheld diagnostic tool shown in FIG. 1 in accordance with an embodiment of the present invention.

FIG. 8 is a simplified flow chart that illustrates sending a fax by the handheld diagnostic tool shown in FIG. 1 in accordance with an embodiment of the present invention.

FIG. 9 is a simplified flow chart that illustrates receiving a fax by the handheld diagnostic tool shown in FIG. 1 in accordance with an embodiment of the present invention.

FIG. 10 is a simplified flow chart that illustrates a full fax test performed by the handheld diagnostic tool shown in FIG. 1 in accordance with an embodiment of the present invention.

### DESCRIPTION OF THE EMBODIMENT

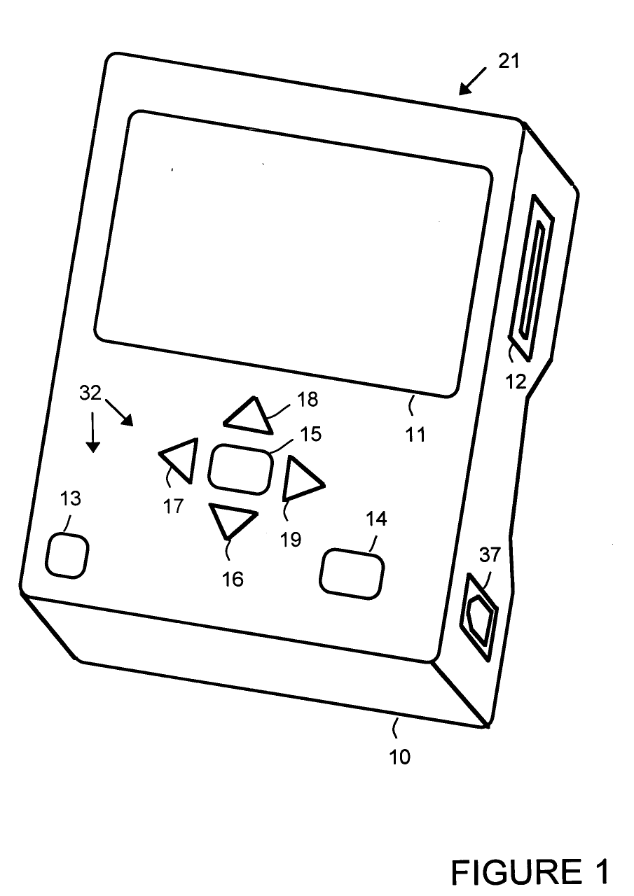

FIG. 1 shows a simplified diagram of a diagnostic tool 10 that is used to test a device under test (DUT). The diagnostic tool 10 includes a display 11, a USB slave connector 37, and another connector 12. Diagnostic tool 10 also can also include, for example, additional connectors and/or the ability to perform wireless communication. For example, display 11 is a liquid crystal display (LCD). A keypad 32 for diagnostic tool 10 includes, for example, a power key 13, a menu key 14, a selection key 15, a direction key 16, a direction key 17, a direction key 18 and a direction key 19.

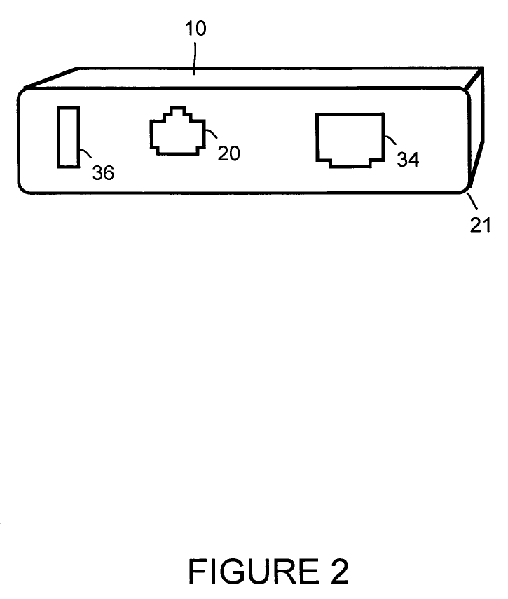

A top region 21 of diagnostic tool 10 contains additional connectors. For example, as shown in FIG. 2, top region 21 of diagnostic tool 10 contains a USB host connector 36, an RJ-45 Ethernet connector 34 and a telephone line connector 20. The telephone line connector may be for analog ISDN, digital proprietary protocols or IP protocol transmissions.

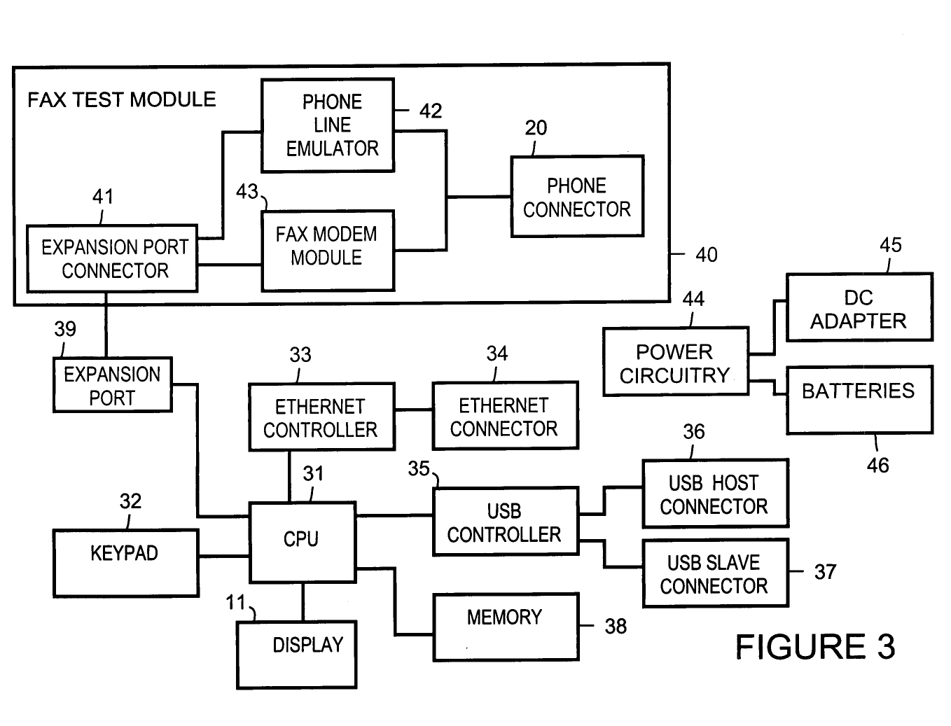

FIG. 3 shows a simplified block diagram for diagnostic tool 10. A central processing unit (CPU) 31 interfaces with keypad 32, an Ethernet controller 33, a universal serial bus (USB) controller 35, memory 38, display 11 and an expansion port 39. Ethernet controller 33 controls communication over Ethernet connector 34. USB controller 35 controls communication over USB host connector 36 and USB slave connector 37.

An expansion port connector 41 within a fax test module 40 is connected to an expansion port 39. Fax test module 40 also includes a phone line emulator 42, a fax modem module 43 and phone connector 20. Phone line emulator provides emulation of a phone line including a disconnect message (an on-hook signal), a connection signal (an off-hook signal) and an alerting message (ring signal).

The connection between expansion port 39 and expansion port connector 41 provides both power and control to phone line emulator 42 and fax modem module 43. Connector 20 is used to connect to a telephone connector of a device under test (DUT) that includes fax capability.

CPU 31 executes programming within memory 38 to control operation of diagnostic tool 10. A user can use keypad 32 to access and interact with menus displayed on display 11. Power circuitry 44 provides power to the components of diagnostic tool 10. Power is supplied to power circuitry 44, for example, by a DC adapter 45 or batteries 46. For example, batteries 46 consist of four AA batteries. Power circuitry 44 generates, for example, a five volt power signal and a 3.3 volt power signal.

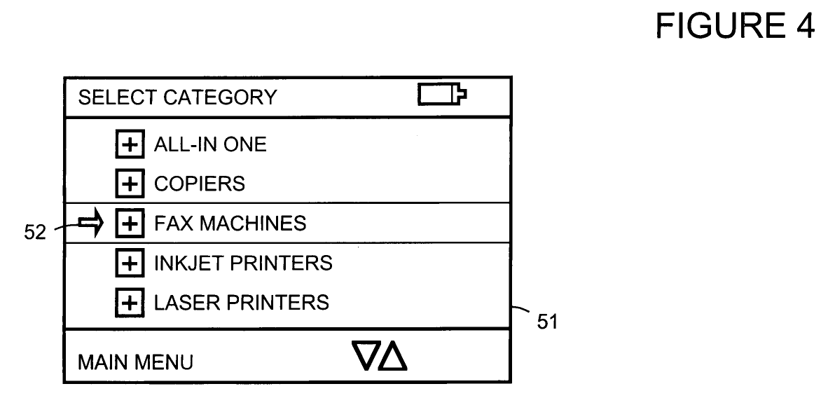

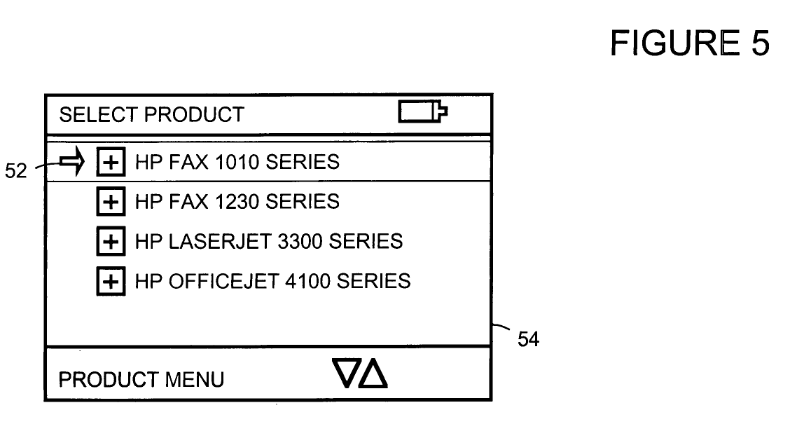

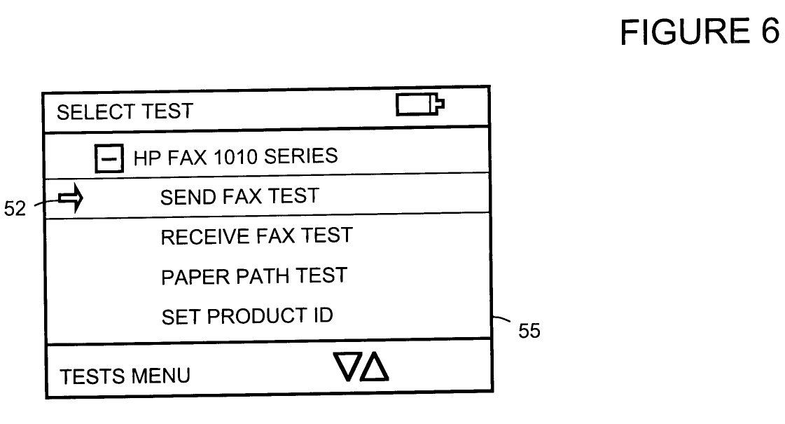

FIG. 4 shows a select category menu 51 as displayed on display 11. A user can use select category menu 51 to select a product category on which to perform tests. Some devices in some categories have fax capability while other devices do not have fax capability. Location of a cursor 52 on select category menu 51 is controlled using direction key 16 and direction key 18 (shown in FIG. 1). In FIG. 4, “Fax Machines” is highlighted and can be selected by the user pressing selection key 15 (shown in FIG. 1).

FIG. 5 shows a select product menu 54 as displayed on display 11. The user can use select product menu 54 to select a product on which to perform tests. Location of cursor 52 on select product menu 54 is controlled using direction key 16 and direction key 18 (shown in FIG. 1). In FIG. 5, “HP fax 1010 series” is highlighted and can be selected by the user pressing selection key 15 (shown in FIG. 1).

FIG. 6 shows a select test menu 55 as displayed on display 11. The user can use select test menu 55 to select a test to be performed. Location of cursor 52 on select test menu 55 is controlled using direction key 16 and direction key 18 (shown in FIG. 1). In FIG. 6, “send fax test” is highlighted and can be selected by the user pressing selection key 15 (shown in FIG. 1).

FIG. 7 shows a send fax menu 56 as displayed on display 11 when a send fax test is performed. The graphics give the user feedback on the progress of the send fax test.

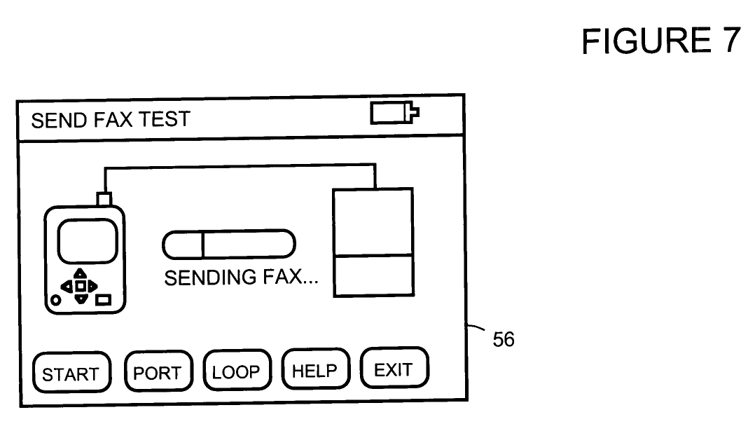

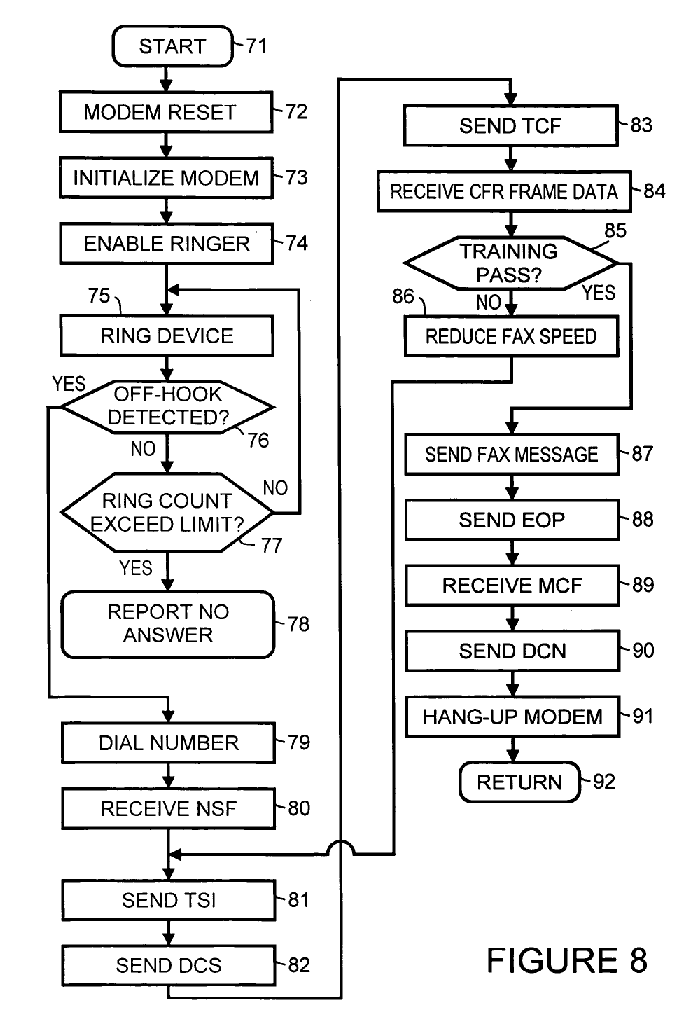

FIG. 8 is a simplified flow chart that illustrates functions performed by diagnostic tool 10 when performing a send fax test via an analog telephone line. The use of an analog telephone line is exemplary and provides enough information for a person of ordinary skill in the art to perform a send fax test with other types of telecommunications connections and protocols. In a block 71, the test starts as the result of a user selection. In a block 72, the modem within fax modem module 43 (shown in FIG. 3) is reset. In a block 73, the modem is initialized. In a block 74, a ringer within phone line emulator 42 (shown in FIG. 3) is enabled. In a block 75, phone line emulator 42 produces a ring signal sent through phone connector 20 to the DUT.

In a block 76, a check is made to determine whether an off-hook is detected indicating the DUT has answered the call. If no off-hook is detected, in a block 77 a check is made to see if a ring count exceeds a ring count limit. If the ring count exceeds the ring count limit, in a block 78, “no answer” is reported back to the user through a message on display 11 (shown in FIG. 1).

If in block 77, the ring count does not exceed the ring count limit, the process returns to block 75 where phone line emulator 42 produces a ring signal sent through phone connector 20 to the DUT.

If in block 76, off-hook is detected, in block 79, a number is dialed. The number is dialed at this point because when the DUT receives the rings, it goes “off-hook”. Diagnostic tool 10 “sees” the “off-hook” condition and sends an ATD command to fax modem module 43. The ATD (Attention Dial the phone) command causes fax modem module 43 to attempt to establish a connection by first producing the auto fax tone (CNG). The DUT needs to see the CNG to know that a Fax device is on the other end of the line.

In a block 80, non-standard facilities (NSF) frame data is received from the DUT. In a block 81, modem training is started by sending a transmitting subscriber identifier (TSI) to the DUT. In a block 82, a digital command signal (DCS) is sent to the DUT. In a block 83, a training check frame (TCF) is sent to the DUT. In a block 84, confirmation to receive frame (CFR) frame data is received from the DUT. In a block 85, diagnostic tool 10 checks to see if training is passed. If training is not passed, in a block 86, fax speed is reduced. Then, diagnostic tool 10 returns to block 81 to restart modem training by sending a transmitting subscriber identifier (TSI) to the DUT.

If in block 85, training is passed, in a block 87, a fax message is sent from diagnostic tool 10 to the DUT. In a block 88, an end of procedure (EOP) is sent by diagnostic tool 10 to the DUT. In a block 89, a message confirmation frame (MCF) is received by diagnostic tool 10. If the MCF is not received, diagnostic tool 10 generates an error message. In a block 90, diagnostic tool 10 sends a disconnect frame (DCN) to the DUT. In a block 91, diagnostic tool 10 hangs up the modem. In a block 92, the send fax test is complete.

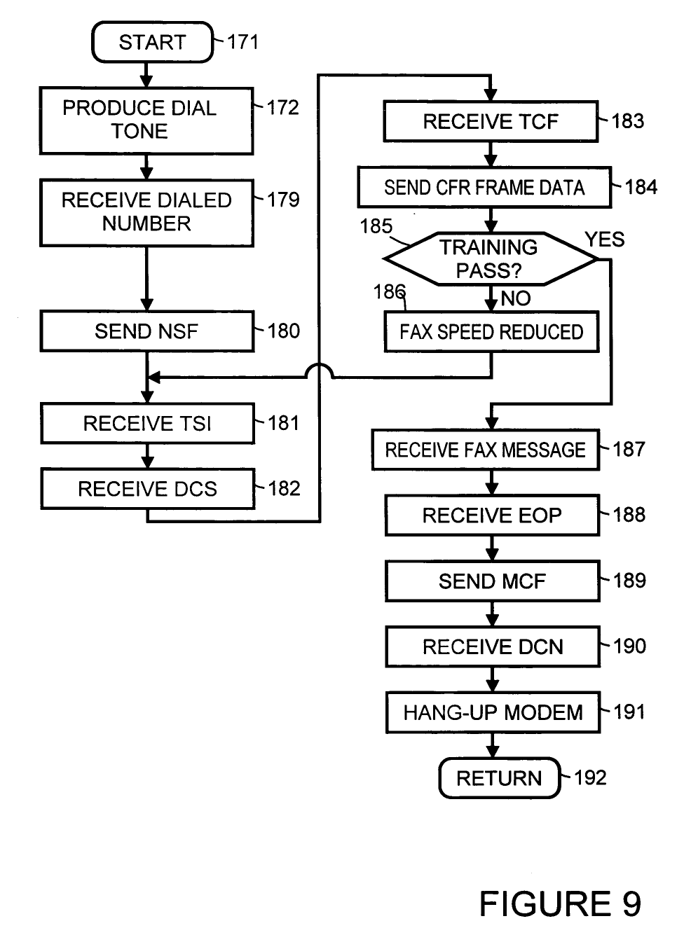

FIG. 9 is a simplified flow chart that illustrates functions performed by diagnostic tool 10 during a receive fax test. In a block 171, the process starts as the result of a user selection. In a block 172, phone line emulator 42 (shown in FIG. 3) produces a dial tone. In a block 179, diagnostic tool 10 receives a dialed number from the DUT. Diagnostic tool, for example, verifies dual tone multi-frequency (DTMF) tones produced by the DUT when the DUT dials the number. In a block 180, diagnostic tool 10 sends a non-standard facilities (NSF) frame data to the DUT. In a block 181, modem training is started by receiving a transmitting subscriber identifier (TSI) from the DUT. In a block 182, a digital command signal (DCS) is sent by the DUT and received by diagnostic tool 10. In a block 183, a training check frame (TCF) from the DUT is received by diagnostic tool 10. In a block 184, diagnostic tool 10 sends a confirmation to receive frame (CFR) frame data to the DUT. In a block 185, a check by the DUT is made to see if training is passed. If training is not passed, in a block 186, the DUT reduces the fax speed. Then, in block 181, modem training is restarted and diagnostic tool receives another transmitting subscriber identifier (TSI) from the DUT.

If in block 185, training is passed, in a block 187 a fax message is sent by the DUT and received by diagnostic tool 10. If the fax message is not received by diagnostic tool 10, diagnostic tool 10 generates an error message. In a block 188, an end of procedure (EOP) is sent by the DUT and received by diagnostic tool 10. If the EOP is not received by diagnostic tool 10, diagnostic tool 10 generates an error message. In a block 189 a message confirmation frame (MCF) is sent by diagnostic tool 10 to the DUT. In a block 190, diagnostic tool 10 receives a disconnect frame (DCN) from the DUT. If the DCN is not received by diagnostic tool 10, diagnostic tool 10 generates an error message. In a block 191, diagnostic tool 10 hangs up the modem. In a block 192, the receive fax test is complete.

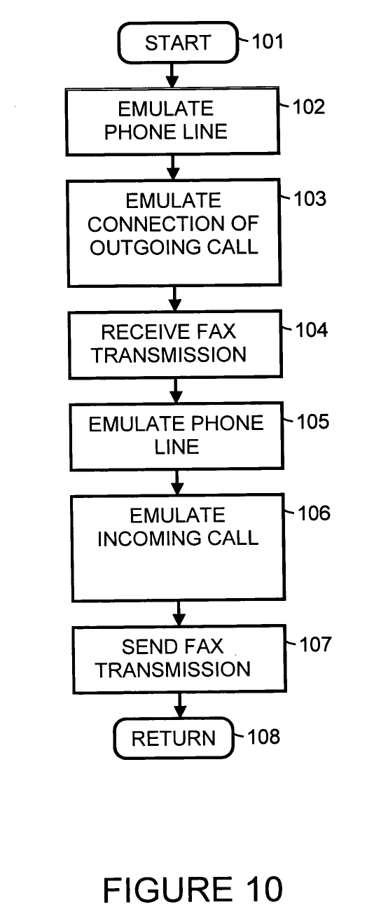

FIG. 10 is a simplified flowchart of a complete fax test. In a block 101, the fax test is started. In a block 102, diagnostic tool 10 emulates a phone line to the DUT. In a block 103, diagnostic tool 10 emulates connection of an outgoing call from the DUT. In a block 104, diagnostic tool 10 receives a fax transmission from the DUT. The contents of the fax transmission are stored in memory 38 (shown in FIG. 3) within diagnostic tool 10. In a block 105, diagnostic tool 10 then emulates to the DUT an idle phone line. In a block 106, diagnostic tool 10 emulates to the DUT an incoming call. In a block 107, diagnostic tool 107 sends a fax transmission to the DUT. The fax transmission includes the contents of the fax transmission that is stored in memory 38. In a block 108, the complete fax test is finished.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

1. A diagnostic tool comprising:
a fax test module, the fax test module including:
a telephone connector,
a fax modem module, and
a phone line emulator;
a display; and,
a processor that causes menus to be shown on the display, the menus allowing a user to select tests to be performed on a device under test, the tests including:
a send fax test, and
a receive fax test;
wherein the menus list devices that can be tested by the diagnostic tool; and,
wherein the menus list at least one device that does not have fax capability and at least one device that does have fax capability.

2. A diagnostic tool as in claim 1 wherein
the menus additionally include a select test menu and a select product menu.

3. A diagnostic tool comprising:
an expansion port;
a fax test module connected to the expansion port, the fax test module including:
a telephone connector,
a fax modem module, and
a phone line emulator;
a display; and,
a processor that causes menus to be shown on the display, the menus allowing a user to select tests to be performed on a device under test, the tests including:
a send fax test, and
a receive fax test.

4. A diagnostic tool as in claim 3 wherein
the menus include a select product menu and a select test menu.

5. A diagnostic tool as in claim 3 wherein
the menus include a select category menu, a select product menu and a select test menu.

6. A diagnostic tool as in claim 3 wherein
wherein the menus list devices that can be tested by the diagnostic tool; and,
wherein the menus list at least one device that does not have fax capability and at least one device that does have fax capability.

7. A handheld diagnostic tool comprising:
power circuitry based on power supplied by battery;
a fax test module connected to the expansion port, the fax test module including:
a telephone connector,
a fax modem module, and
a phone line emulator;
a display; and,
a processor that causes menus to be shown on the display, the menus allowing a user to select tests to be performed on a device under test, the tests including:
a send fax test, and
a receive fax test.

8. A handheld diagnostic tool as in claim 7 wherein
the menus include a select product menu and a select test menu.

9. A handheld diagnostic tool as in claim 7 wherein
the menus include a select category menu, a select product menu and a select test menu.

10. A diagnostic tool as in claim 7 wherein
wherein the menus list devices that can be tested by the diagnostic tool; and,
wherein the menus list at least one device that does not have fax capability and at least one device that does have fax capability.

11. A method for testing a device under test (DUT) wherein the DUT includes fax capability, the method comprising:
connecting a cable from the DUT to a diagnostic tool; and,
sending a fax from the diagnostic tool to the DUT, including the following:
emulating, by the diagnostic device over the cable, a phone line to the DUT,
performing fax transmission of data from the diagnostic tool to the DUT, and
terminating the fax transmission.

12. A method as in claim 11 wherein emulating the phone line includes the following:
producing an alert signal.

13. A method as in claim 11 additionally comprising the following performed before sending the fax:
selecting by a user the device under test from a plurality of devices listed on a menu by the diagnostic tool, the plurality of devices including at least one device that does not have fax capability and at least one device that does have fax capability.

14. A method for testing a device under test (DUT) wherein the DUT includes fax capability, the method comprising:
connecting a cable from the DUT to a diagnostic tool; and,
sending a fax from the DUT to the diagnostic tool, including the following:
emulating, by the diagnostic device over the cable, a phone line to the DUT,
performing fax transmission of data from the DUT to the diagnostic tool, and
terminating the fax transmission.

15. A method as in claim 14 wherein emulating the phone line includes the following:
producing a dial tone; and,
receiving a dialed number.

16. A method as in claim 14 additionally comprising the following performed before sending the fax:
selecting by a user the device under test from a plurality of devices listed on a menu by the diagnostic tool, the plurality of devices including at least one device that does not have fax capability and at least one device that does have fax capability.

17. A method as in claim 14 additionally comprising:
sending a fax from the diagnostic tool to the DUT, including the following:
emulating again, by the diagnostic device, a phone line to the DUT,
performing fax transmission of data from the diagnostic tool to the DUT, and
terminating the fax transmission.

18. A method as in claim 17 wherein emulating again the phone line includes the following:
producing an alert signal.

19. A method as in claim 17 additionally comprising the following performed before sending the fax:
selecting by a user the device under test from a plurality of devices listed on a menu by the diagnostic tool, the plurality of devices including at least one device that does not have fax capability and at least one device that does have fax capability.

20. A diagnostic tool comprising:
a module means for sending and receiving fax, the module means including:
connector means for providing a telephone connection,
fax means for producing and receiving fax transmissions, and
emulator means for emulating a phone line;
display means for displaying menus to a user; and,
processing means for controlling display of the menus by the display means, the menus allowing the user to select tests to be performed on a device under test, the tests including:
a send fax test, and
a receive fax test;
wherein the menus list devices that can be tested by the diagnostic tool; and,
wherein the menus list at least one device that does not have fax capability and at least one device that does have fax capability.
